(19) United States
(12) Patent Application Publication
(10) Pub. No.: US 2021/0004705 A1
(43) Pub. Date: Jan. 7, 2021

(54) USER BEHAVIOR PREDICTING METHOD AND DEVICE FOR EXECUTING PREDICTED USER BEHAVIOR

(71) Applicant: LG ELECTRONICS INC., Seoul (KR)

(72) Inventor: Nam Joon KIM, Anyang-si (KR)

(73) Assignee: LG ELECTRONICS INC., Seoul (KR)

(21) Appl. No.: 16/697,977

(22) Filed: Nov. 27, 2019

(30) Foreign Application Priority Data
Jul. 1, 2019 (KR) 10-2019-0078648

(51) Int. Cl. G06N 7/00; G06N 20/00

(52) U.S. Cl. CPC G06N 7/005; G06N 20/00

(57) ABSTRACT

User behavior was recorded with equipment that employed artificial intelligence (AI) and/or a machine learning algorithm which predicts user behavior based on the behavior that was recorded. The apparatus records movement related to predicted user behaviors which is accomplished by communicating with provided 5G external servers and other electronic devices. If user behavior can be predicted by this method, users can then control devices without actually operating the equipment and settings can then predict the next movement dependent upon the situation.

### CROSS-REFERENCE TO RELATED APPLICATION

This present application claims benefit of priority to Korean Patent Application No. 10-2019-0078648, entitled “USER BEHAVIOR PREDICTING METHOD AND DEVICE FOR EXECUTING PREDICTED USER BEHAVIOR,” filed in the Republic of Korea on Jul. 1, 2019, the entire disclosure of which is incorporated herein by reference.

### BACKGROUND

### 1. Technical Field

The present disclosure relates to a method and a device for executing an operation associated with a predicted user behavior by predicting a user behavior, and more particularly, to a user behavior predicting method and a device for executing a predicted user behavior, which may predict a user behavior at a certain time later from any time point based on the correlation between data according to the movement, action, site of the user with time in a user equipment or an external device connected with the user equipment, and then execute the operation associated with the predicted user behavior in the external device.

### 2. Description of Related Art

Recently, development of a user-centered User Interface (UI), User Experience (UX), and the like for a vehicle for providing vehicle information to a driver efficiently and effectively has been actively progressing.

An example of such development may be a voice recognition system, or the like, and a web-based voice recognition system may provide not only a simple service but also user-customized information.

In addition, as a smartphone technology is supported on a vehicle platform technology, a situation determination system based on smartphone information is mounted in the vehicle, and a vehicle-specific service based on the smartphone information is also provided extensively.

In particular, the related arts 1 and 2 disclose a technology capable of analyzing existing or repeated information, such as a driver's hobby and characteristics, and providing appropriate information by recognizing the driver's condition during driving based on the analyzed information.

Although the related art 1 discloses a technology capable of providing a correct answer by analyzing all data that may be generated during driving of the vehicle such as driver UX, driving situation of the vehicle, and surrounding situation of the vehicle through real-time analysis and learning data update on vehicle characteristics and driver characteristics, and tracking a possible problem in real time, there is a limitation in presenting a technology capable of executing the operation associated with the predicted driver activity by predicting the driver's activity collected from a mobile terminal possessed by the driver.

Although the related art 2 discloses a technology capable of collecting a user's life log through a smartphone, and predicting the user's next behavior from the past history through the collected life log, there is a limitation in presenting a technology in which the next behavior information of the predicted user may control the external device connected with the smartphone.

The above-described background technology is technical information that the inventors hold for the derivation of the present disclosure or that the inventors obtained in the process of deriving the present disclosure, and may not be regarded as known technology disclosed to the general public prior to the filing of the present application.

### RELATED ART DOCUMENTS

### Patent Documents

Related Art 1: Korean Patent No. 10-1807514 (registered on Dec. 5, 2017)

Related Art 2: Korean Patent No. 10-1702502 (registered on Jan. 26, 2017)

### SUMMARY OF THE DISCLOSURE

An object of the present disclosure is to control an external device without having to directly operate or set the external device used by a user when the behavior pattern of the user is predicted so that the next behavior of the user is made according to the situation.

Another object of the present disclosure is to predict the next behavior of the user according to the correlation of the data of the movement, action, and site with time so that a user equipment or an external device connected to the user equipment may operate.

Still another object of the present disclosure is to control a processor of an external device according to the predicted next behavior based on information collected in a user equipment even if the user does not transmit user information to the external device connected to the user equipment, thereby preventing the information collected in the user equipment from being leaked outwards.

Yet another object of the present disclosure is to enable an external device connected to a user equipment to operate in an optimized state required by a user based on information collected in the user equipment.

The present disclosure is not limited to what has been described above, and other aspects and advantages of the present disclosure will be understood by the following description and become apparent from the embodiments of the present disclosure. It is also to be understood that the aspects of the present disclosure may be realized by means and combinations thereof set forth in claims.

A user behavior predicting method according to an embodiment of the present disclosure is a method for predicting a user behavior through a user equipment. To this end, the user behavior predicting method includes recording a user behavior as movement data (M(t)), action data (A(t)), and site data (S(t)) together with time information (t) through information received from at least one of a sensor, an external signal receiver, and an application executor of a user equipment, generating a user behavior predictive model by learning a probability correlation between M(t1), A(t1), and S(t1) at any time point (t1) and M(t1+Δt), A(t1+Δt), and S(t1+Δt) after a certain time (t1+Δt), and allowing an external device connected to the user equipment to execute an operation associated with the user behavior by the user equipment based on the generated user behavior predictive model, when the user behavior is sensed based on the information received from the sensor and the processor.

That is, the user behavior predicting method according to an embodiment of the present disclosure predicts the behavior pattern of the user with time with respect to the user behavior at a certain time later from any time point at the user equipment or the external device connected with the user equipment, and executes an operation associated with the predicted user behavior at the external device. At this time, it is possible to execute the operation associated with the predicted user behavior without the user directly operating or setting the external device, thereby receiving the optimized service required by the user using the external device according to the individual situation.

At this time, if the user stays at a first site for a certain time or more, then moves to a second site to stay at the second site for a certain time, the user behavior predicting method may include recording the M(t) representing the movement from the first site to the second site, recording the A(t) representing the user behavior confirmed from a signal input through an interface of the user equipment or information received from the external device, and recording the S(t) representing the user site based on the position information confirmed by the external device or the user equipment.

The user behavior predicting method of the present disclosure may not transmit user information to the external device connected with the user equipment in order to execute the user behavior to be executed through the external device, and may serve as a hub having information for the user equipment to control the external device. As a result, it is possible to control processor of the external device even without directly inputting the user information to the external device, thereby preventing the personal information collected in the user equipment from being leaked to the outside.

At this time, in the recording the M(t), the M(t) may record any one time point of a time point at which the user moves from the first site to the second site or a time point at which the user has arrived at the second site.

According to the recording the M(t) of the present embodiment, it is possible to collect the movement information of the user according to various conditions, thereby predicting the behavior pattern of the user according to the movement information of the user more accurately.

In addition, in the recording the A(t), the A(t) may be any one of purchase information in which the user has arbitrarily purchased an item or a setting command of the external device input through the interface of the external device.

Specifically, the A(t) may be information for setting an air conditioner of a vehicle, information for setting a destination by using the vehicle navigation, or the like, in the case of the setting command of the external device input through the interface of the external device.

According to the recording the A(t) of the present embodiment, it is possible to collect the user behavior information under various conditions, thereby predicting the next behavior to be executed by the user more accurately.

Meanwhile, in the generating the user behavior predictive model, the probability correlation between the M(t₁), A(t₁), and S(t₁) of the any time point (t₁) and the M(t₁+Δt), A(t₁+Δt), and S(t₁+Δt) after a certain time, the probability correlation between the M(t₁), A(t₁), and S(t₁) of the any time point (t₁) and the M(t₁ Δt), A(t₁ Δt), and S(t₁ Δt) after a certain time may be any one of a probability, the probability correlation between the A(t₁) of any time (t₁) to A(t₁ Δt) of the time point (t₁ Δt) after a certain time may be any one of a probability, the probability correlation between S(t₁) of any time (t₁) to A(t₁ Δt) of the time point (t₁ Δt) after a certain time may be any one of a probability.

Through the probability correlation according to the present embodiment, the behavior pattern of the user according to the user lifestyle may be predicted. That is, it is possible to probabilistically predict the next action of the user to be executed, thereby improving the consistency of the operation of the external device executed in association with the operation to be executed by the user.

Meanwhile, in the generating the user behavior predictive model, the user behavior predictive model may be generated based on any one of a method in which a user moves from the M(t₁) at any time point (t₁) to the M(t₁+Δt) of the time point (t₁+A) after a certain time, or an external temperature while moving from M(t₁) to the M(t₁+Δt).

Through the generating the user behavior predictive model according to the present embodiment, it is possible to specify a situation of deciding the behavior pattern of the user according to various situations.

In addition, the generating the user behavior predictive model may generate the user behavior predictive model predictable after a certain time (t₁+Δt) based on the user behavior information collected by an artificial intelligence home appliance mounted with a camera and a user equipment from any time point (t₁) to a certain time later (t₁+Δt).

Through the generating the user behavior predictive model according to the present embodiment, the user using the user equipment may be in a specific space and connected with various home appliances and artificial intelligence devices, and it is possible to learn the behavior pattern of the user more accurately through the usage patterns of various home appliances, artificial intelligence devices, and various user equipment.

In addition, the predicting the user behavior and performing the operation associated with the predicted user behavior may first execute the operation that is expected to be instructed to the user equipment through the interface of the user equipment or the external device based on the predicted user behavior predictive model.

When the behavior pattern of the user is predicted through the predicting the user behavior and performing the operation associated with the predicted user behavior according to the present embodiment, the user may receive the optimized service for each individual, and each situation without directly having to operate or set the external device.

A device for executing a predicted user behavior according to an embodiment of the present disclosure may include an information recording capable of recording a user behavior as movement data (M(t)), action data (A(t)), and site data (S(t)) together with time information (t), a learner configured to learn a probability correlation between M(t₁), A(t₁), and S(t₁) at any time point (t₁) and M(t₁+Δt), A(t₁+Δt), and S(t₁+Δt) after a certain time (t₁+Δt), an behavior predictor configured to generate a user behavior predictive model based on the learned correlation between the M(t₁), the A(t₁), and the S(t₁) at any time point (t₁) and the M(t₁+Δt), the A(t₁+Δt), and the S(t₁+Δt) after the certain time (t₁+Δt), and a device controller configured to control a user equipment to allow an external device connected with the user equipment to execute an operation associated with the user behavior when the user behavior is sensed.

The device for executing the predicted user behavior according to the present embodiment predicts the behavior pattern of the user, and allows the external device to perform the operation associated with the predicted user behavior. At this time, it is possible to execute the operation associated with the predicted user behavior without the user directly operating and setting the external device, thereby receiving the optimized service required by the user using the external device according to the individual's situation.

The information recording of the device for executing the predicted user behavior according to an embodiment of the present disclosure may include a movement data recording configured to receive information on whether to move from a first site to a second site when the user stays at the first site for a certain time or more at time (t), then moves to the second site to stay at the second site for a certain time or more, an action data recording configured to receive the user behavior information confirmed from a signal input through an interface of the user equipment or the information received from the external device at the time (t), and a site data recording configured to receive information of a user's site confirmed based on the position information confirmed by the external device or the user equipment at the time (t).

Since the activity pattern of the user may be predicted according to the movement, action, and site of the user through the information recording according to the present embodiment, the activity of the user may be predicted under various conditions.

The movement data recording of the device for executing the predicted user behavior according to an embodiment of the present disclosure may include information on any one of the time point at which the user moves from the first site to the second site or the time point at which the user has arrived at the second site.

Through the movement data recording according to the present embodiment, it is possible to accurately analyze the movement change aspect of the user and to collect more accurate information of the movement data (M(t)).

In addition, the action data may receive information on any one of the purchase information that the user has purchased any goods or the setting command of the external device input through the interface of the external device.

Specifically, the action data according to the present embodiment may receive information for setting an air conditioner of a vehicle, information for setting a destination by using a vehicle navigation, or the like, in the case of the setting command of the external device input through the interface of the external device.

The probability correlation between the M(t₁), A(t₁), and S(t₁) of the any time point (t₁) and the M(t₁+Δt), A(t₁+Δt), and S(t₁+Δt) after a certain time, the probability correlation between the M(t₁), A(t₁), and S(t₁) of the any time point (t₁) and the M(t₁ Δt), A(t₁ Δt), and S(t₁ Δt) after a certain time may be any one of a probability, the probability correlation between the A(t₁) of any time (t₁) to A(t₁ Δt) of the time point (t₁ Δt) after a certain time may be any one of a probability, the probability correlation between S(t₁) of any time (t₁) to A(t₁ Δt) of the time point (t₁ Δt) after a certain time may be any one of a probability.

In addition, the behavior predictor of the device for executing the predicted user behavior according to an embodiment of the present disclosure generate the user behavior predictive model based on any one of a method in which the user moves to the M(t₁+Δt) of the time point (t₁+A) after a certain time from the M(t₁) of any time point (t₁) or an external temperature while moving from the M(t₁) to the M(t₁+Δt).

Furthermore, the behavior predictor may generate the user behavior predictive model predictable after a certain time (t₁+A) based on the user behavior information collected from the user equipment and the artificial intelligence home appliance equipped with a camera for a certain time (t₁+Δt) from any time point (t₁).

Through the behavior predictor according to the present embodiment, it is possible to specify a situation of deciding the behavior pattern of the user according to the user's situation in various situations.

Meanwhile, the device controller may first execute the predicted user behavior through the user equipment or the external device connected with the user equipment based on the predicted user behavior predictive model.

Through the device controller according to the present embodiment, a user who uses the user equipment may be in a specific space and connected with various home appliances and artificial intelligence devices, and it is possible to learn the behavior pattern of the user more accurately through the usage patterns of various home appliances, artificial intelligence devices, and various user equipment.

In addition, it is possible to predict the user behavior, perform the operation associated with the predicted user behavior, and first execute the operation expected to be instructed to the user equipment through the interface of the user equipment or the external device based on the predicted user behavior predictive model.

In addition, a method for executing predicted user behavior, can include receiving sensor information from at least one of a sensor, an external signal receiver, or an application executor of a user equipment, recording movement data (M(t)), action data (A(t)) and site data (S(t)) associated with a user behavior together with time information (t) based on the sensor information, generating a user behavior predictive model by learning a probability correlation between first movement data of the user behavior (M(t1)), first action data of the user behavior (A(t1)), and first site data of the user behavior (S(t1)) at a first time point (t1), and second movement data of the user behavior (M(t1+Δt), second action data of the user behavior (A(t1+Δt), and second site data of the user behavior at a second time point (S(t1+Δt) after the first time point (t1) and in response to determining the user behavior based on the sensing information and an output of the user behavior predictive model, transmitting a signal from an external device to the user equipment to execute an operation associated with the user behavior by the user equipment.

In addition, a device for executing predicted user behavior, can include a memory configured to store user behavior information and a controller configured to receive sensor information from at least one of a sensor, an external signal receiver, or an application executor of a user equipment, record, in the memory, movement data (M(t)), action data (A(t)) and site data (S(t)) associated with a user behavior together with time information (t) based on the sensor information, generate a user behavior predictive model by learning a probability correlation between first movement data of the user behavior (M(t1)), first action data of the user behavior (A(t1)), and first site data of the user behavior (S(t1)) at a first time point (t1), and second movement data of the user behavior (M(t1+Δt), second action data of the user behavior (A(t1+Δt)), and second site data of the user behavior at a second time point (S(t1+Δt) after the first time point (t1), and to the user equipment to execute an operation associated with the user behavior by the user equipment.

Other aspects and features than those described above will become apparent from the following drawings, claims, and detailed description of the present disclosure.

According to the present disclosure, it is possible to predict the next action executed by the user from the activity information of the user with time collected in the user equipment or processor. The external device connected to the user equipment collects the predicted action information, and executes the action associated with the collected predicted action information of the user. As a result, it is possible to receive the predicted service without the user directly operating or setting the external device, thereby improving the convenience of the user.

In addition, it is possible to enable the user equipment to serve as the hub having the information for controlling the external device without transmitting the user information to the external device connected with the user equipment in order to execute the user behavior to be executed through the external device. That is, the user equipment retains the behavior pattern of the user information and inputs the user behavior predictive model to the external device, in the state where the behavior pattern of the user information is not input or transmitted to the external device, and the external device executes the operation associated with the predicted user behavior through the user behavior predictive model. At this time, when the connection between the external device and the user equipment is released, the input user behavior predictive model information may be deleted so that processor of the external device may be controlled in the state where the actual user behavior information is not stored in the external device. Accordingly, it is possible to prevent the personal information collected in the user equipment from being exposed to the outside.

The effects of the present disclosure are not limited to those mentioned above, and other effects not mentioned may be clearly understood by those skilled in the art from the following description.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is an exemplary diagram of an environment for collecting a user behavior including a plurality of devices connected with a user equipment and a network for connecting them with each other in order to predict the user behavior according to an embodiment of the present disclosure.

FIG. 2 is a schematic block diagram of a device for predicting a user behavior according to an embodiment of the present disclosure.

FIG. 3 is a schematic block diagram of an Information recording and a learner in the device for predicting the user behavior of FIG. 2.

FIG. 4 is a diagram showing an example of the behavior pattern predictive learning and inference of the user based on movement data, action data, and site data of the user obtained together with time information by a device for predicting a user behavior.

FIG. 5 is an exemplary diagram for explaining the prediction of the behavior pattern of the user of FIG. 4 in response to the user behavior change with time.

FIG. 6 is a flowchart of a user behavior learning process according to an embodiment of the present disclosure.

### DETAILED DESCRIPTION OF THE EMBODIMENTS

Advantages and features of the present disclosure and methods of achieving the advantages and features will be more apparent with reference to the following detailed description of example embodiments in connection with the accompanying drawings. However, the description of particular example embodiments is not intended to limit the present disclosure to the particular example embodiments disclosed herein, but on the contrary, it should be understood that the present disclosure is to cover all modifications, equivalents and alternatives falling within the spirit and scope of the present disclosure. The example embodiments disclosed below are provided so that the present disclosure will be thorough and complete, and also to provide a more complete understanding of the scope of the present disclosure to those of ordinary skill in the art. In addition, in the following description of the present disclosure, a detailed description of known technologies incorporated herein will be omitted when it may make the subject matter of the present disclosure rather unclear.

The terms used in this application is for the purpose of describing particular embodiments only and is not intended to limit the disclosure. As used herein, the articles “a,” “an,” and “the,” include plural referents unless the context clearly dictates otherwise. The terms “comprises,” “comprising,” “includes,” “including,” “containing,” “has,” “having” or other variations thereof are inclusive and Accordingly specify the presence of stated features, integers, steps, operations, elements, and/or components, but do not preclude the presence or addition of one or more other features, integers, steps, operations, elements, components, and/or group thereof. Although the terms “ordinal numbers” such as first, second and the like are used to describe various structural elements, the structural elements should not be defined by the terms. The terms are used merely for the purpose to distinguish an element from the other elements.

Hereinafter, embodiments of the present disclosure will be described in detail with reference to the accompanying drawings, and in the description with reference to the accompanying drawings, the same or corresponding components have the same reference numeral, and a duplicate description therefor will be omitted.

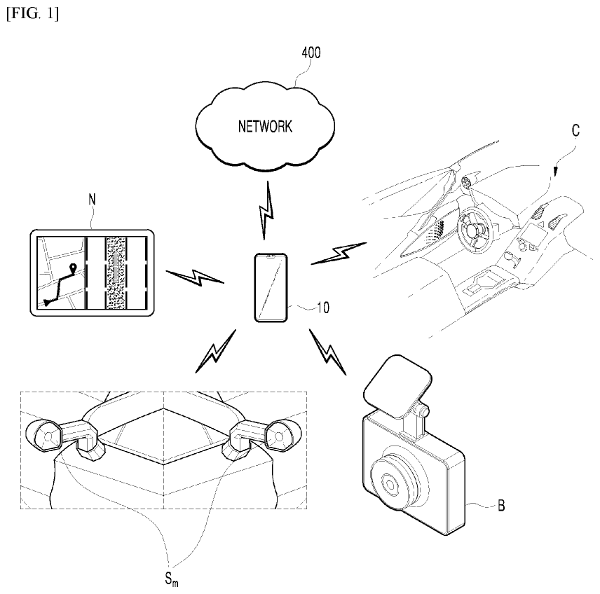

FIG. 1 is an exemplary diagram of an environment for collecting a user behavior including a plurality of devices connected with a user equipment and a network for connecting them with each other in order to predict the user behavior according to an embodiment of the present disclosure.

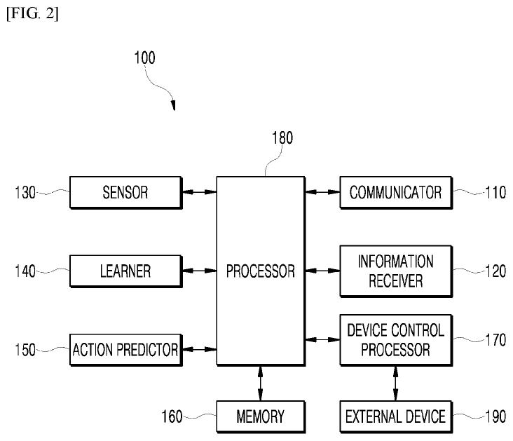

Referring to FIG. 1, user devices (e.g.: portable smartphone 100), cars(C), various devices equipped in cars (e.g.: Black box (B), Navigation system(N), Side mirrors(Sm) etc.,) and various electronic devices (hereunder mentioned as external devices 20 (see FIG. 2) used in houses and offices are connected to communicate each other by a network 20.

User devices 100 also includes communication part 110 (see FIG. 2), which can send and receive data through wired and wireless networks 20.

User device 100 and external device 30 can be connected to each other in 5G communication environment. Also they can connect to each other and work with other devices used in houses and offices other than the devices described FIG. 1 under the internet connection.

User device 100 can save personal data according to each user. Based on the personal data saved in user device 100, it can act like a hub to control external device 30 that cannot collect personal data.

Specifically, personal data can include SNS, personal schedule, invoices for purchasing certain products. More specifically, personal data can be messaging services sending and receiving through user device 100, personal schedule saved in user device 100, tracking information saved by GPS system in user device 100. This personal data can be continuously saved or updated by using user device 100 and they can be saved in the memory mentioning later 160 (see FIG. 2).

Furthermore, personal data can command to execute the operation of external device 30 by using saved personal data in user device 100 when user device 100 and external device 30 are connected.

For example, if a commuting route is saved in the morning during the weekdays and a route to church route is saved during the weekend, the user device can save and learn this user's routes and patterns. When the user uses the device that saved and learned this pattern device during the weekdays, the navigation system can be automatically set up to navigate to the commuting route by using the user's saved commuting information while the user approaches a car.

Like this way, the user's status can be checked by a camera and a video sensor in a car when the user enters a car after exercising. For example, the user's face and attires etc., can be acquired, then based on the user's status, it can provide better car environment by regulating car air conditioning system and other systems.

Furthermore, outside temperature measured by user device and period that the user stayed outside checked by GPS system are fed into the car controlling system, the vehicle can start the air conditioning system before the user enters the vehicle providing increased comfort.

In other words, this present disclosure's embodiment is to save time for using user device 100, space and information according to user's movement and to predict the user's next movement based on the personal data saved in user device 100. And execute the predicted user behavior in external device 30 such as car before the user acts.

The user equipment 100 may include a communication terminal capable of performing functions of a computing device, and may include, but is not limited to, a user-operable desktop computer, a smartphone, a notebook computer, a tablet PC, a smart TV, a mobile phone, a personal digital assistant (PDA), a laptop computer, a media player, a micro server, a global positioning system (GPS) device, an E-book reader, a digital broadcasting terminal, a navigation system, a kiosk information system, an MP3 player, a digital camera, a home appliance, and any other mobile or immobile computing devices. Furthermore, the user equipment may be a wearable terminal having a communication function and a data processing function, such as a watch, glasses, a hair band, or a ring. The user equipment 100 is not limited to the aforementioned items, but may be any terminal capable of web-browsing.

The network 20 may be a database server, which provides big data required for applying a variety of artificial intelligence algorithms and data related to voice recognition. Furthermore, the server 300 may include a web server or application server that enables remote control of the speech recognition device 100 by using an application or web browser installed on the user equipment 100.

Artificial intelligence (AI) is an area of computer engineering science and information technology that studies methods to make computers mimic intelligent human behaviors such as reasoning, learning, self-improving, and the like.

In addition, artificial intelligence does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed. Specifically, the Machine Learning may be a technology for researching and constructing a system for learning, predicting, and improving its own performance based on empirical data and an algorithm for the same. Machine learning algorithms, rather than only executing rigidly-set static program commands, may be used to take an approach that builds models for deriving predictions and decisions from inputted data.

The network 20 may serve to connect the speech recognition device 100 and the user equipment 100 to each other. The network 20 may include a wired network such as a local area network (LAN), a wide area network (WAN), a metropolitan area network (MAN), or an integrated service digital network (ISDN), and a wireless network such as a wireless LAN, a CDMA, Bluetooth®, or satellite communication, but the present disclosure is not limited to these examples.

The network 20 may also send and receive information using short distance communication and/or long distance communication. The short distance communication may include Bluetooth®, radio frequency identification (RFID), infrared data association (IrDA), ultra-wideband (UWB), ZigBee, and Wi-Fi (wireless fidelity) technologies, and the long distance communication may include code division multiple access (CDMA), frequency division multiple access (FDMA), time division multiple access (TDMA), orthogonal frequency division multiple access (OFDMA), and single carrier frequency division multiple access (SC-FDMA).

The network 20 may include a connection of network elements such as a hub, a bridge, a router, a switch, and a gateway. The network 20 may include one or more connected networks, for example, a multi-network environment, including a public network such as an internet and a private network such as a safe corporate private network. The access to the network 20 may be provided via one or more wired or wireless access networks. In addition, the network 20 may support 5G communication and/or an Internet of things (IoT) network for exchanging and processing information between distributed components such as objects.

FIG. 2 is an exemplary diagram showing the appearance of a speech recognition device according to an embodiment of the present disclosure. Hereinafter, a description of components that are identical to the components described with reference to FIG. 1 will be omitted.

Referring to FIG. 2, the user device 100 can include a communicator 110, an action predictor 150, a sensor 130, an information receiver 120, a learner 140, a memory 160, and a device control processor 170 and processor 180.

The communicator 110 interfaces to provide a transmission/reception signal that is generated when using the user device 100 in the form of packet data in cooperation with the network 20.

Additionally, the communicator 110 can serve to receive a designated information request signal from the external device 30 and the user device 100, and to transmit the information processed by the user device 100 to the external device 30 and user device 100. Furthermore the communicator 110 can be a device that includes the hardware and software necessary to transmit and receive a control or a data signal through a wired or wireless connection with another network device.

In the present embodiment, the external device 30 refers to a device such as a car (C), a black box (B), installed in a car (C), a navigation (N), a side mirror (Sm) of the vehicle, and various home and office appliances, for example, air conditioners, refrigerators, and washing machines, and etc.,

The information receiver 120 can record user's actions stored in the user device 100 along with time information (t), movement data (M(t)), action data (A(t)), and space data (S(t)). This information receiver 120 could include a movement data 120-1, an action data 120-2, and a space data120-3 capable of receiving information of M (t), A (t), and S (t).

The movement data 120-1 may receive movement information from the user. For example, the movement data 120-1 may receive information indicating the movement when the user moves from the first location to the second location when the user remains at the first location for more than a predetermined time at a time t and moves to the second location and stays at the second location for a certain time.

For example, if the user wakes up at a specific time in the house, it may be assumed that the sleeping bedroom is the first location. The action data (A(t)) may assume that the kitchen is the second location when the user regularly stays in the kitchen for a certain time to drink water after waking up.

The action data 120-2 may receive user behavior information which is identified from the signal input through the interface of the user device 100 or information received from the external device 30 at a time t.

Referring to the above-described embodiment, the action data 120-2 receives the user's action of drinking water when the user moves from the bedroom, the first location, and stays in the kitchen, the second location, after waking up.

The space data 120-3 may record location information where a user is located based on the location information collected by the external device 30 or the user device 100. The user's recorded location may be used as a data for predicting the user's next behavior.

In addition, with reference to the above-described embodiment, the space data 120-3 records space movement information from first location, the bedroom, to a second location, the kitchen. The recorded space data can be used for studying user's regular movement from the first location (bedroom) to the second location (kitchen) in order to drink water after waking up. The studied data can be information or a command for controlling a water purifier, a refrigerator and etc., which are external devices for drinking water in a device control processor 170 that would be described later in this disclosure. For example, after determining that the cup is placed close to the water outlet of the water purifier with the learned data, the device control processor 170 enables to take actions such as discharging water or opening a home bar of the refrigerator in which the water container is stored.

The sensor 130 may include a proximity sensor, a temperature sensor, an image sensor, and the like that senses a surroundings of the user device 100. For example, the sensor 130 can measure an external temperature by using a temperature sensor when the user goes outside after waking up, and may check the user's state by using an image sensor when the user gets into the car. Of course, the sensor 130 not only is able to be installed on the user device but also is able to be installed in the room mirror, the instrument panel, and others.

In the present embodiment, the sensor 130 is limited to a proximity sensor, a temperature sensor, and an image sensor. However, it is not limited only to these and is able to include various sensors such as a humidity sensor and a vibration capable of detecting surroundings of the user device 100. The information detected by the sensor 130 may be stored in memory 160.

The Learner 140 can learn the probability correlation between M (t₁), A (t₁) and S (t₁) at any time (t₁) and (t t+Δt) M (t₁+Δt), A (t t+Δt) and S(t₁+Δt) a certain time after. The learner 140 may include a first learner 142, a second learner 144, and an analyzer 146.

The first learner 142 can learn the user's action data A (t) according to a time change (t1->t₁+Δt), and the second learner 144 can learn user's space data (S(t)) according to the change of location.

The first learner 142 can learn the user's action data A (t) according to a time change (t₁->t₁+Δt), and the second learner 144 can learn user's space data (S(t)) according to the change of the location. With reference to the above-described embodiment, the first learner 142 recognizes the time the user wakes up (t₁) in the bedroom (first location) in the house, learns (t₁+Δt) information that is time for movement from the bedroom (first location) to the kitchen (second location) or arrival time to the kitchen (second location).

That is, the first learner 142 can study user's behavior that the user moves to the kitchen at the time of waking up (t₁) or the action the user takes during the arrival time to the kitchen (t₁+Δt). Referring to the embodiment, the first learner 142 is to learn the action which is the user drinks water.

Based on that input, the second learner 144 can learn the movement to the kitchen from the waking up time (t₁) or movement path during the arrival time (t₁+Δt) to the kitchen. Referring to the embodiment, the second learner 144 can learn a path from the bedroom (first location) to the kitchen (second location).

In the meantime, if the user behavior is learned through the first learner 142 and the second learner 144, the probability generated in the first learner 142 and the second learner 1(44) can be analyzed by analyzer 146.

For example, the analyzer 146 can analyze the probability of the behavior that the user wakes up (t₁), moves ((t₁+Δt) from the bedroom, first location, to the kitchen, second location, and drinks water.

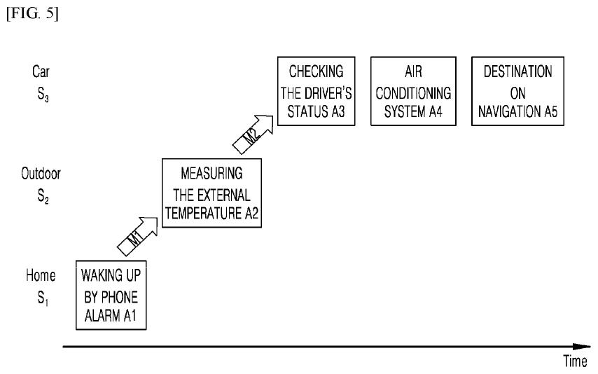

Also, the analyzer 146, for example, can analyze the probability of the behavior of going out (Action A1 and movement M1 in FIG. 5) after preparing to go to work or to go out for a certain time after (t₁+Δt) when the user wakes up at a specific time. (Action A1 in FIG. 5).

The behavior predictor 150 can predict the user's next behavior based on personal data generated by using the user device 100. The behavior predictor 150 in this present embodiment can generate a user behavior predictive model predicted after a certain amount time (t₁+Δt) based on the behavior information collected from user device and an artificial intelligent home appliance with a camera that learn the information of the user device 100 used during the time from at an any time point (t₁) to a certain time after (t₁+Δt).

In detail, the behavior predictor 150 can generate a user behavior predictive model based on one of the information of a method that user moves from at M(t₁) at any time point (t₁) to M(t₁+Δt) at a certain time after (t₁+A) or of external temperature while user moves from M(t₁) to M(t₁+Δt).

Additionally, user can move to the car (M1 and M2 in FIG. 5) after waking up (A1 in FIG. 5) by the user device 100. At this point (t), the information receiver 120 may receive information how to go to the car , by walk or take a bus, after going out or may get the external temperature while user goes to the car after waking up (A1 of FIG. 5) by the user device 100 alarm. In this way, user behavior information received from the information receiver 120 can be a data to predict user's next behavior.

For example, the chance of the user runs to the car is high and measured external temperature is 25˜27° C., an behavior predictor 150 creates user behavior predictive model by recognizing that “The user's body temperature goes up” and let air conditioning system in a car run when user gets into the car.

Additionally, the behavior predictor 150 can generate predictable user behavior predictive model a certain time after (t₁+Δt) based on the behavior information collected from the user device 100 and the artificial intelligence home appliance during the time from at any time point (t₁) to a certain time after (t₁+Δt).

Referring to the previous example, it can be analyzed in the analyzer 146 that the probability of behavior for the user to wake up (t₁), move from the bedroom, first location, to a kitchen, second location (t₁+Δt) and then drink water is high. With this analysis, the user behavior predictive model like “user will move to drink water after waking up” can be created.

Also it can be analyzed that the chance to go out after waking up (A1 of FIG. 5) is high (A2 of FIG. 5). At this point, it is assumed that the user executes an action to measure the external temperature before going out or outside then the user behavior predictive model as “measure external temperature” can be generated when it reaches a certain time in the user device 100 or when it is confirmed that the user goes outside from the house checked by GPS system in the user device 100.

The memory 160 may include a volatile or non-volatile recording medium and have recorded therein various data required for operations of the speech recognition device 100. The recording medium is configured to store data readable by the processor 180, and may include a hard disk drive (HDD), solid state disk (SSD), silicon disk drive (SDD), ROM, RAM, CD-ROM, a magnetic tape, a floppy disk, a light data storage device, and the like. In this embodiment, the information stored in the memory 160 will be described in a context appropriate for each situation.

Limited data can be saved in memory 160. For example, personal data received from the information receiver 120 of the user device 100 and studied data learned from the information received from information receiver 120 can be stored in memory 160.

The processor 180 can output the processed result that can control the external device based on the user behavior model generated based on learned information. The processed result, for example, is a data to execute the expected behavior before commanding the behavior predicted to the device control processor 170 through the external device connected to the user device when user behavior is detected.

More specifically, it can be analyzed that the probability of taking an action for the user to wake up (t₁), to move (t₁+Δt) from the bedroom (first location) to the kitchen (second location) and to drink water referring is high refer to the previous embodiment. Based on this analysis, user behavior predictive model like “the user will move in order to drink water” can be generated.

Based on the prediction result, the device control processor 170 controls the external device 30 to perform functions like discharging water from the water purifier, or opening a home bar of the refrigerator where the water container is stored by determining that the cup is located adjacent to the water outlet of the water purifier.

For example, the chance of the user runs to the car is high and measured external temperature is 25˜27° C., the behavior predictor 150 creates user behavior predictive model by recognizing that “The user's body temperature goes up” and let air conditioning system in a car run when user gets on the car.

When such a predicted result is sent to the external device 30, device control processor 170 initiates air conditioning system that is the external device 30 before the user gets into the car. The user can have better environment in the car due to this function.

On top of that, the device control processor 170 can control the user device 100 to inform the external temperature before the user checks the external temperature when user behavior predictive model of “measure external temperature” is generated. The convenience can be improved by this.

The processor 180 may be a central processor of a kind capable of driving a control software installed in the memory 160, controlling the external device 30 and other various functions. Here, the processor 180 may include a device of any kind capable of processing data, such as a processor. Here, ‘the processor’ may, for example, refer to a data processing device embedded in hardware, which has physically structured circuitry to perform a function represented by codes or instructions contained in a program. As one example of the data processing device embedded in the hardware, a microprocessor, a central processor (CPU), a processor core, a multiprocessor, an application-specific integrated circuit (ASIC), a field programmable gate array (FPGA), and the like may be included, but the scope of the present disclosure is not limited thereto.

In the present example embodiment, the speech recognition device 100 may perform machine learning, such as deep learning, on user's spoken utterance signals received, and the memory 160 may store data for use in machine learning, result data, and so on.

Deep learning, which is a subfield of machine learning, enables data-based learning through multiple layers. As the number of layers in deep learning increases, the deep learning network may acquire a collection of machine learning algorithms that extract core data from multiple datasets.

Deep learning structures may include an artificial neural network (ANN), and may include a convolutional neural network (CNN), a recurrent neural network (RNN), a deep belief network (DBN), and the like. The deep learning structure according to the present embodiment may use various structures well known in the art. For example, the deep learning structure according to the present disclosure may include a CNN, a RNN, and a DBN. RNN is an artificial neural network structure which is formed by building up layers at each instance, and which is heavily used in natural language processing and the like and effective for processing time-series data which vary over a course of time. A DBN includes a deep learning structure formed by stacking up multiple layers of a deep learning scheme, restricted Boltzmann machines (RBM). A DBN has the number of layers formed by repeating RBM training. A CNN includes a model mimicking a human brain function, built under the assumption that when a person recognizes an object, the brain extracts the most basic features of the object and recognizes the object based on the results of complex processing in the brain.

Meanwhile, the artificial neural network may be trained by adjusting connection weights between nodes (if necessary, adjusting bias values as well) so as to produce desired output from given input. Also, the artificial neural network may continuously update the weight values through learning. Furthermore, methods such as back propagation may be used in training the artificial neural network.

Meanwhile, the speech recognition device 100 may be provided with an artificial neural network and perform machine learning-based user recognition and user's voice color recognition, which use received audio input signals as input data.

The processor 180 may include an artificial neural network (ANN), for example, a deep neural network (DNN) such as a CNN, an RNN, or a DBN, and perform learning of the DNN. As a machine learning method for such an artificial neural network, both unsupervised learning and supervised learning may be used. In response to setting information, the processor 180 may update a tone recognition ANN structure after execution of learning.

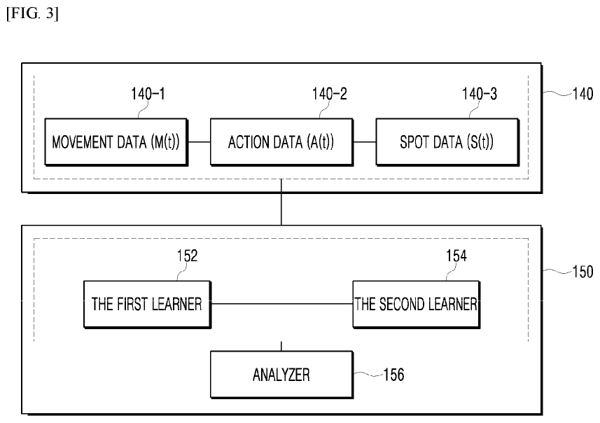

FIG. 3 is a schematic block diagram of an Information recording and a learner in the device for predicting the user behavior of FIG. 2. Hereinafter, a description of components that are identical to the components described with reference to FIGS. 1 to 2 will be omitted.

Referring to FIG. 3, the information receiver 120 recording user behavior along with movement data M (t), action data A (t), and space data S (t) through the user device 100 can include the movement data 120-1, an action data 120-2, and a space data 120-3

The movement data 120-1 can receive user's movement information. For example, the movement data 120-1 can take information about the movement from the first location to the second location when the user stays in a certain amount time in the first location and then moves to the second location to stay for a certain amount time at time (t).

Specifically, when the user moves from the first location to the second location, the GPS of the user device 100 detects this and stores the user's movement information. This movement information of the user is received by the movement data 120-1.

During this time, the movement data 120-1 can receive information of either the time when the user moves to the second location by getting out of the first location or the arrival time that the user arrives to the second location.

According to the above-described example, the movement data 120-1 receives time information when the user moves to the kitchen (the second location) after waking up (t₁) in the bed room (the first location) or after the user moves to the kitchen (the second location) after waking up (t₁).

Likewise, movement information can be analyzed by using received information in the movement data120-1, and the result of studying this understood user's movement information is to operate the external device 30 for the user's next movement in advance.

The action data 120-2 can receive user behavior information collected from a signal input through the interface of the user device 100 or received from the external device 30 at time (t).

In more details, at least one of the information from purchasing information obtained by a user who purchases a certain item from payment information received from the outside, information about an application executed on a user device obtained from an application executor or executed movement in the external device 30 figured out from the transmitted signal in the external device 30 can be recorded.

For example, the action data can be time information from that the alarm sound of the user device 100 set for waking up the user (“phone alarm wakeup (A1)” in FIG. 5). Also, the action data can be information of the external temperature that can be measured by the user device 100 when the user is ready to go to work and/or go out (“outside temperature check (A2)” in FIG. 5). In addition, the action data can be information about like user's state (“driver status check A3” in FIG. 5) after the user gets on the car, air conditioning system of the vehicle set by the user (“air conditioning system of (A4)” in FIG. 5), road guidance information set by the user (“navigator destination (A5)” in FIG. 5) and etc.

The received action data information can be learning data for predicting a user's behavior. In other words, when it is learned that previously performed actions “(A1) to (A5)” repeatedly occur, when the user device 100 receives the action information (Al), checking outside temperature action (A2) is executed and actions to operate a car (A3 or A5) are performed. Accordingly, after predicting the user's actions based on the action data information, the user is able to receive the predicted service without operating the external device 30 directly by letting the external device 30 operate with the action related to the user's next behavior beforehand.

The space data 120-3 can receive the location information of the user. Received space information can be used as a data to predict the next behavior.

When the information receiver 120 receives user's movement, action and space information over time, the information can be learned through learner 140. In order for this, the learner 140 can include the first learner 142, the second learner 144 and analyzer 146.

The first learner 142 can study the probability of occurring the received information from the user device 100 and the external device 30 during from A(t₁) at any time (t₁) to A(t₁+Δt) a certain time after (t₁+A). It means the first learner 142 can learn user's action data according to the time change (t₁->t₁+Δt).

The second learner 144 can learn the probability of user's space information based on space information received the user device 100 and the external device 30 during from S(t₁) at any time point (t₁) to S(t₁+Δt) after a certain time after (t₁+A). In other words, the second learner 144 is to study the user location data by location change.

The analyzer 146 can analyze the probability of the correlation between M(t₁), A(t₁) and S(t₁) at any time point(t₁) and M(t₁+Δt), A(t₁+Δt), and S(t₁+Δt) a certain time after (t₁+Δt) by analyzing the probability of occurrence in the first learner 142 and the second learner 144.

To explain further, this means the analyzer 146 can stochastically analyze the relation among actions that the user prepares to go to work/to go out after waking up (action A1 in FIG. 5) at a certain time(t₁), goes out (action A1 and movement M1) after predetermined time (t₁+Δt) and checks the outside temperature (action A2 in FIG. 5)

At this time, the analyzer needs to collect personal data that will be stored in the user device 100 daily, weekly or monthly and the learner 140 needs to study “frequently occurring” actions in order to analyze the user behavior in the analyzer 146. For instance, the information receiver 120 can receive user's movement data (M(t)), action data(A(t)) and space data (S(t)) along with time information from the above described contents.

Through the received information, the analyzer 146 can analyze whether the probability of the user going outside (movement M1) after waking up (action 1) is higher than the probability of the user not going outside.

Similar to this, the analyzer 146 can analyze the relation among the actions, (action A2) the user checks the outside temperature after the user goes outside, (movement M2) how the user moves to the car, (action A3) the user's status in a car, how the user travels to the car, be it walking (30% chance), running (60% chance) and using public transportation such as bus (10% chance) and/or (action A4) air conditioning system operation.

In summary, the learner 140 can analyze the association of each action probabilistically by learning the user's behavior received from the information receiver 120. The probability correlations generated in this way create user behavior predictive models to help users predict behavior, the action associated with the predicted user's behavior can be performed in an external device (e.g., a vehicle air conditioning system).

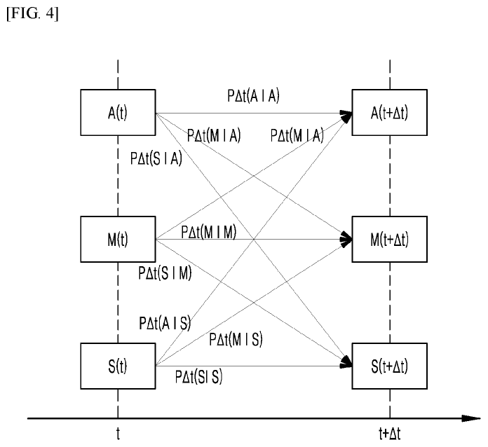

FIG. 4 is a diagram showing an example of the behavior pattern predictive learning and inference of the user based on movement data, action data, and site data of the user obtained together with time information by a device for predicting a user behavior, and FIG. 5 is an exemplary diagram for explaining the prediction of the behavior pattern of the user of FIG. 4 in response to the user behavior change with time. Hereinafter, a description of components that are identical to the components described with reference to FIGS. 1 to 3 will be omitted.

Referring to FIG. 4, movement data (M(t)), action data(A(t)) and space data (S(t)) about user's behavior at any time point (t) can be received through information receiver 120.

At this time, it shows the examples how to deduce probability correlations from each data input, the probability (PΔt(M|S), PΔt(S|M)) between M(t) and S(t), the probability (PΔt(A|S), PΔt(S|A)) between A(t) and S(t), the probability (PΔt(M|A), PΔt(A|M). between M(t) and A(t).

Specifically, the probability correlation between M(t₁), A(t₁) & S(t₁) at any time point (t₁) and M(t₁+Δt), A(t₁+Δt), & S(t₁+Δt) after a certain amount time can infer the possibility correlation of each M(t₁+Δt), A(t₁+Δt), and S(t₁+Δt) can occur recorded after M(t₁) at any time point (t₁)/a certain time after (t₁+A t).

It also can infer to a probability of each occurrence of M(t₁+Δt), A(t₁+Δt), & S(t₁+Δt) recorded at a certain time after (t₁+A t) after happening A(t₁) at a certain time point (t₁).

M(t), A(t), S(t) described in FIG. 4 can be the user's behavior patterns at a certain time point (t), with reference to the above-described embodiment and FIG5, M(t), A(t), S(t) inside of house (S1 in FIG. 5) can be a situation (A1 in FIG. 5) that the user wakes up by the alarm saved in the user device 100.

Later, M(t+Δt), A(t+Δt), S(t+Δt) at a certain time after (t+Δt) can be received by the information receiver. 120.

This provides examples how to deduce about probability correlation of each data like, the probability (PΔt(M|S), PΔt(S|M)) between M(t+Δt) and S(t+Δt), the probability (PΔt(A|S), PΔt(S|A)) between A(t+Δt) and S(t+Δt) and the probability (PΔt(M|A), PΔt(A|M)) between M(t+Δt) and A(t+Δt).

It also describes the example how to deduce the probability (PΔt(A|A)) that is the probability A(t) and A(t+Δt) from a certain time point (t) and a certain time after point (t+Δt), the probability (PΔt(S|S)) that is the probability of S(t) and S(t+Δt).

M(t+Δt), A(t+Δt), S(t) described in FIG. 4 can be the user's behavior patterns at a certain time point (t), with reference to the above-described embodiment and FIG. 5, M(t), A(t), S(t) inside of house (S1 in FIG. 5) can be a situation (A1 in FIG. 5) that the user wakes up by the alarm saved in the user device 100.

M (t+Δt) of which from a certain point (t) after a certain point (t+Δt) can be a movement of moving out of the house (M1 in FIG. 5), A(t+Δt) can S(t+Δt) can be an action to check the external temperature by the user device 100 (A2 in FIG. 5) from the outside (S2 in FIG. 5)

After that, M(t+Δt) a certain time after(t+Δt) can be referred as a movement (M2 in FIG. 5) that is moving to a car from the outside, A(t+Δt) and S(t+Δt) can be situations like checking the status of the user who gets on the car (A3 in FIG. 5), controlling the car air conditioning system due to the outside temperature which was checked before the user gets into the car (A4 in FIG. 5) or setting up the car navigation system based on the previous schedule (A5 in FIG. 5)

After collecting the movement data, the action data, and the space data from the certain time and a certain time after like this, and a probability value of each data can be extracted. According to the previous embodiment, it is to extract the probability of generating an alarm (A1) of the user device 100 in the house (S1) on a weekday morning. Similarly, the probability of which an alarm is generated on a weekday morning (A1), and the user may go out of the house (M1) and check the outside temperature (A2) through the user device 100 can be extracted. Probability value extracted in this way calculates that there will be a high possibility for the user to go to the car when an alarm of the user device 100 can happen in the house on weekday morning.

If the external temperature is confirmed during the morning and/or time on weekdays by this prediction, the navigation system according to the user's destination or air conditioning system can be operated in advance. In this way, it can predict the user's behavior and execute the work on the external devices (e.g.: air conditioning system and navigation system) related to the predicted user's behavior for user's convenience and improving the users experience when using the external device.

Alternatively, the user might not go to work despite it being weekday morning. In this case, the user can control the work of external device 30 directly or stop the execution with the external device operating algorithm of connected to the user device 100.

Although the embodiment of the present invention describes a process in which a user wakes up to go to work as an example, a variety of embodiments other than this can be done.

For example, the information on the road preferred by the user can be learned and extracted based on the collected information after collecting the vehicle driving information. If the user is on driving based on the extracted information and it is determined that it is on the preferred road, the navigation system can be programmed to drive to the preferred road by predicting that the user drives to the preferred road.

In addition, text information that is frequently received may be used for a period of collecting the user's behavior information to predict the user's behavior. For example, it can be checked that appointments with acquaintance or events are repeated through the message information received in the user device. In this case, navigation can collect and study the message information in the user device. Based on the studied message information, it can predict the user's route on the appointment day. That is, the information in a car navigation system is to be set to the appointment location by predicting that the user will move to the appointment location on the appointment date. Because of this, it can go to the appointment location even if the user does not operate the navigation system.

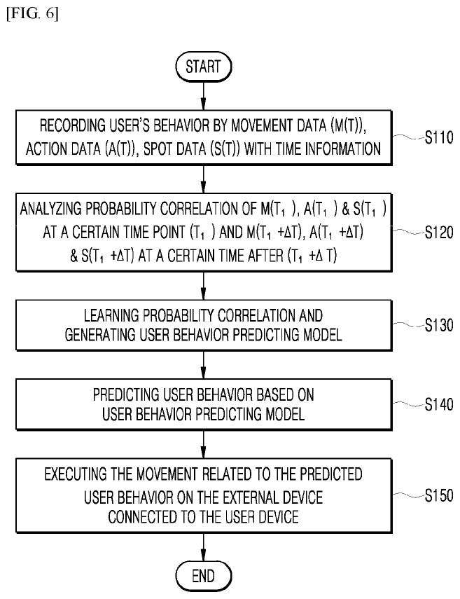

FIG. 6 is a flowchart of a user behavior learning process according to an embodiment of the present disclosure. Hereinafter, a description of components that are identical to the components described with reference to FIGS. 1 to 5 will be omitted.

Referring to FIG. 6, at an operation of S110, the user's behavior is recorded as the movement data M(t)), the action data A (t) and the space data S (t) along with time information (t) through the information received from at least one of a sensor, an external signal receiver, and the application executor of the user device 100.

The user device 100 can receive user's movement information. For example, information about the movement from the first location to the second location when the user stays in a certain amount time in the first location and then moves to the second location to stay for a certain amount time at the time t can be recorded.

Also the user device 100 can receive and record the user's behavior information calculated by signal input through the interface of the user device 100 or information received from the external device 30.

Also the user device 100 can record the user's location based on the location information grasped by the external device or the user device.

For example, the user device 100 can record M(t), the movement from when the user wakes up in the bedroom (first location) in the house and the user stays for a certain amount time in the kitchen (second location) regularly to drink water.

M(t) information at this time can be the time when the user moves from the first location to the second location or the time when the user arrives to the second location. In this embodiment, either the time when the user moves from the bedroom (first location) to the kitchen (second location) or the time when the user arrives to the kitchen (second location) is recorded.

Furthermore, the user device 100 can record A(t) about the user's behavior information, drinking water after the user wakes up and moves from the bedroom, the first location to the kitchen, the second location to drink water.

Also the user device 100 can record S(t) about the first space, the bedroom and the second space, and where the user moves to next (kitchen)

When recording user's behavior, the probability correlation between M(t₁), A(t₁) and S(t₁) at any time point(t₁) and M(t₁+Δt), A(t₁+Δt) and S(t₁+Δt) at a certain time after (t₁+Δt) can be learned on operation S120.

Specifically, the probability of each occurrence of M(t₁+Δt), A(t₁+Δt) and S(t₁+Δt) recorded at a certain time after (t₁+Δt) from M(t₁) at any time point (t₁), the probability of each occurrence of M(t₁+Δt), A(t₁+Δt) and S(t₁+Δt) recorded at a certain time after (t₁+Δt) from A(t₁) at any time point (t₁), the probability of each occurrence of M(t₁+Δt), A(t₁+Δt) and S(t₁+Δt) recorded at a certain time after (t₁+Δt) from S(t₁) at any time point (t₁) can be studied.

Referring to the above mentioned example, the user's behavior that includes the user moving to the kitchen at the time of waking up (t₁) or during the time (t₁+Δt) the user arrives to the kitchen is learned and it can be studied that the user moves to the kitchen at the time of waking up (t₁) or the route during the time (t₁+Δt) the user arrives to the kitchen.

Later, the user behavior predictive model can be generated according to the studied probability correlation on operation S130. Specifically, the user's next moment can be predicted by using the personal data created by using the user device 100.

For example, it is inferred that it has a high chance of the behavior of that the user wakes up (t₁) , moves (t₁+Δt) from the bedroom (first location) to the kitchen (second location) and drinks water, the user behavior predictive model about “the user will move to drink water after waking up” can be created.

Later in operation of S140, the user's behavior can be predicted through the information received from at least one of a sensor, an external signal receiver, and the application executor.

That is, the user behavior can be predicted based one of the method how the user moves to S(t₁+Δt) a certain time after from S(t₁) at any time point (t₁) or the external temperature while the user moves from S(t₁) to S(t₁+Δt).

Specifically, if the user behavior predictive model such as “the user will move to drink water after waking up” is created, it is predicted that the user would move from the bedroom (first location) to the kitchen (second location) to drink water after waking up.

At the time of predicting user's behavior, it is predicted based on the user behavior collected from the user device or artificial intellectual home devices with a camera during the time from at any time point (t₁) to a certain time after(t₁+Δt).

In operation S150, operation related predicted behavior can be run in the external device 30 connected to the user device 100.

Referring to the previous embodiment, it is predicted that the user will go to the kitchen (second location) from the bedroom (first location) in order to drink water after waking up, the external device 30 can then be controlled to run the water from the water purifier after verifying that a cup is located near to the water exhaust or to open the home bar of the refrigerator where water is stored.

In other words, the predicted movement that is expected to be commanded to the user device 100 by the user device interface or the external device based on the user behavior predictive model is to be executed in advance.

The example embodiments described above may be implemented through computer programs executable through various components on a computer, and such computer programs may be recorded on computer-readable media. Examples of the computer-readable media include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program codes, such as ROM, RAM, and flash memory devices.

The computer programs may be those specially designed and constructed for the purposes of the present disclosure or they may be of the kind well known and available to those skilled in the computer software arts. Examples of computer programs may include both machine codes, such as produced by a compiler, and higher-level codes that may be executed by the computer using an interpreter.

As used in the present disclosure (especially in the appended claims), the singular forms “a,” “an,” and “the” include both singular and plural references, unless the context clearly states otherwise. Also, it should be understood that any numerical range recited herein is intended to include all sub-ranges subsumed therein (unless expressly indicated otherwise) and Accordingly, the disclosed numeral ranges include every individual value between the minimum and maximum values of the numeral ranges.

Also, the order of individual steps in process claims of the present disclosure does not imply that the steps must be performed in this order; rather, the steps may be performed in any suitable order, unless expressly indicated otherwise. In other words, the present disclosure is not necessarily limited to the order in which the individual steps are recited. All examples described herein or the terms indicative thereof (“for example,” etc.) used herein are merely to describe the present disclosure in greater detail. Accordingly, it should be understood that the scope of the present disclosure is not limited to the example embodiments described above or by the use of such terms unless limited by the appended claims. Also, it should be apparent to those skilled in the art that various modifications, combinations, and alternations may be made depending on design conditions and factors within the scope of the appended claims or equivalents thereof.

The present disclosure is thus not limited to the example embodiments described above, and rather intended to include the following appended claims, and all modifications, equivalents, and alternatives falling within the spirit and scope of the following claims.

What is claimed is:

1. A method for executing predicted user behavior, the method comprising:
receiving sensor information from at least one of a sensor, an external signal receiver, or an application executor of a user equipment;
recording movement data (M(t)), action data (A(t)) and site data (S(t)) associated with a user behavior together with time information (t) based on the sensor information;
generating a user behavior predictive model by learning a probability correlation between first movement data of the user behavior (M(t1)), first action data of the user behavior (A(t1)), and first site data of the user behavior (S(t1)) at a first time point (t1), and second movement data of the user behavior (M(t1+Δt), second action data of the user behavior (A(t1+Δt), and second site data of the user behavior at a second time point (S(t1+Δt)) after the first time point (t1); and
in response to determining the user behavior based on the sensing information and an output of the user behavior predictive model, transmitting a signal from an external device to the user equipment to execute an operation associated with the user behavior by the user equipment.

2. The method of claim 1, wherein the recording includes:
in response to the user staying at a first site for a predetermined amount of time, moving to a second site and staying at the second site for a predetermined amount of time, recording the movement data (M(t)) representing the moving from the first site to the second site, the action data (A(t)) corresponding to the user behavior based on a signal input through an interface of the user equipment or information received from the external device, and the site data (S(t)) representing a location of the user based on position information from the external device or the user equipment.

3. The method of claim 2, wherein the movement data (M(t)) corresponds to a time point at which the user moves from the first site to the second site or a time point at which the user arrives at the second site.

4. The method of claim 2, wherein the action data (A(t)) includes purchase information for an item purchased by the user or command information corresponding to a setting command input by the user for the external device or the user equipment.

5. The method of claim 1, wherein the user behavior predictive model includes:
the probability correlation between first movement data of the user behavior (M(t1)), the first action data of the user behavior (A(t1)), and the first site data of the user behavior (S(t1)) at the first time point (t1), and the second movement data of the user behavior (M(t1+Δt), the second action data of the user behavior (A(t1+Δt), and the second site data of the user behavior at the second time point (S(t1+Δt)),
a probability correlation between the first action data of the user behavior (A(t1)) and the second action data of the user behavior (A(t1+Δt)), and
a probability correlation between the first site data of the user behavior (S(t1)) and the second action data of the user behavior (A(t1+Δt)).

6. The method of claim 1, wherein the operation to be executed by the user equipment is determined based on a manner in which the user moves from a first location associated with the first site data (S(t1)) to a second location associated with the second site data (S(t1+Δt)) or an external temperature while the user moves from the first location to the second location.

7. The method of claim 6, wherein the manner in which the user moves includes at least one of walking, running, or vehicular travel.

8. The method of claim 1, wherein the user behavior predictive model is generated based on user behavior information collected by an artificial intelligence home appliance mounted with a camera and a state of the user equipment at any time point from the first time point (t1) to the second time point (S(t1+Δt).

9. The method of claim 1, wherein the operation to be executed by the user equipment is determined based on an expected user instruction determined based on the user behavior predictive model.

10. The method of claim 9, further comprising:
automatically executing the operation by the user equipment without a user input before the user inputs the expected user instruction.

11. A device for executing predicted user behavior, comprising:
a memory configured to store user behavior information; and
a controller configured to:
receive sensor information from at least one of a sensor, an external signal receiver, or an application executor of a user equipment,
record, in the memory, movement data (M(t)), action data (A(t)) and site data (S(t)) associated with a user behavior together with time information (t) based on the sensor information,
generate a user behavior predictive model by learning a probability correlation between first movement data of the user behavior (M(t1)), first action data of the user behavior (A(t1)), and first site data of the user behavior (S(t1)) at a first time point (t1), and second movement data of the user behavior (M(t1+Δt), second action data of the user behavior (A(t1+Δt), and second site data of the user behavior at a second time point (S(t1+Δt)) after the first time point (t1), and
in response to determining the user behavior based on the sensing information and an output of the user behavior predictive model, transmit a signal to the user equipment to execute an operation associated with the user behavior by the user equipment.

12. The device of claim 11, wherein the controller is further configured to:
in response to the user staying at a first site for a predetermined amount of time, moving to a second site and staying at the second site for a predetermined amount of time, record, in the memory, the movement data (M(t)) representing the moving from the first site to the second site, the action data (A(t)) corresponding to the user behavior based on a signal input through an interface of the user equipment or information received from the external device, and the site data (S(t)) representing a location of the user based on position information from the external device or the user equipment.

13. The device of claim 12, wherein the movement data (M(t)) corresponds to a time point at which the user moves from the first site to the second site or a time point at which the user arrives at the second site.

14. The device of claim 12, wherein the action data (A(t)) includes purchase information for an item purchased by the user or command information corresponding to a setting command input by the user for the external device or the user equipment.

15. The device of claim 11, wherein the user behavior predictive model includes:
the probability correlation between first movement data of the user behavior (M(t1)), the first action data of the user behavior (A(t1)), and the first site data of the user behavior (S(t1)) at the first time point (t1), and the second movement data of the user behavior (M(t1+Δt), the second action data of the user behavior (A(t1+Δt), and the second site data of the user behavior at the second time point (S(t1+Δt)),
a probability correlation between the first action data of the user behavior (A(t1)) and the second action data of the user behavior (A(t1+Δt)), and
a probability correlation between the first site data of the user behavior (S(t1)) and the second action data of the user behavior (A(t1+Δt)).

16. The device of claim 11, wherein the operation to be executed by the user equipment is determined based on a manner in which the user moves from a first location associated with the first site data (S(t1)) to a second location associated with the second site data (S(t1+Δt)) or an external temperature while the user moves from the first location to the second location.

17. The device of claim 16, wherein the manner in which the user moves includes at least one of walking, running, or vehicular travel.

18. The device of claim 11, wherein the user behavior predictive model is generated based on user behavior information collected by an artificial intelligence home appliance mounted with a camera and a state of the user equipment at any time point from the first time point (t1) to the second time point (S(t1+Δt)).

19. The device of claim 11, wherein the operation to be executed by the user equipment is determined based on an expected user instruction determined based on the user behavior predictive model.

20. The device of claim 19, wherein the controller is further configured to:
control the user equipment to automatically execute the operation without a user input before the user inputs the expected user instruction.
